(19) United States
(12) Patent Application Publication
(10) Pub. No.: US 2005/0284024 A1
(43) Pub. Date: Dec. 29, 2005

(54) Sliding window arrangement

(76) Inventors: Lars Bjorkman, Vaxjo (SE); Rune Ljung, Hoganas (SE); Ulf Lind, Jonstorp (SE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/529,222

(22) PCT Filed: Oct. 2, 2003
(86) PCT No.: PCT/SE03/01527

§ 371 Date: Mar. 25, 2005

(30) Foreign Application Priority Data
Oct. 23, 2002 (SE) 0203115-1
Nov. 22, 2002 (SE) 0203455-1

(51) Int. Cl. E05D 15/22

(52) U.S. Cl. 49/176

(57) ABSTRACT

A sliding window arrangement has an upper and a lower horizontal guide rail and a vertical rectangular window which is mounted between the guide rails and displaceable along the same. The window has at each upper corner a guide means which engages the upper guide rail, and at each lower corner a guide means which engages the lower guide rail. The lower guide rail has a stop means which is positioned so that the window, when on displacement towards a displacement end position it reaches this position, abuts against the stop means in its lower front corner and, owing to its kinetic energy, is tilted to a tilted position about an imaginary tilt axis extending perpendicular to the window. In the tilted position, the guide means located in the lower rear corner of the window is disengaged from the lower guide rail. The window has an operating means, by means of which the guide means located at the upper rear corner of the window is disengageable from the upper guide rail to allow the window in the tilted position to be pivoted about a vertical pivot shaft placed at the front lateral edge of the window, from a closed position to an open position.

### TECHNICAL FIELD

The present invention relates to a sliding door arrangement, which has an upper and a lower horizontal guide rail and a vertical window which is mounted between the guide rails and displaceable laterally along the same, said window having a rectangular frame with a pane mounted therein, and in the vicinity of each of its two upper frame corners having an upper guide means which engages the upper guide rail, and in the vicinity of each of its two lower frame corners having a lower guide means, which engages the lower guide rail, the window in a displacement end position being pivotable about an essentially vertical pivot shaft positioned at one lateral edge of the window, between a closed position, in which it extends along the guide rails, and an open position.

### BACKGROUND ART

For glazing in balconies, for instance, is it known to use sliding window arrangements of this type. In such glazing-in, a plurality of sliding window arrangements are arranged side by side along a balcony side. The upper guide rails of the sliding window arrangements are arranged side by side and formed on a common upper aluminium section, and their lower guide rails are correspondingly arranged side by side and formed on a common lower aluminium section. Each window is slidable back and forth along its two guide rails. The windows may take such a relative displacement position that they together cover the entire width of the balcony side, and they can also be displaced to an essentially common end position, in which the entire width of the balcony side less slightly more than the width of one window is open. To be pivoted between a closed position, in which the window extends along its guide rails, and an open position, each window is in a prior-art design mounted in a displaceable outer frame, on which the upper and lower guide means are mounted. The frame, which is mentioned by way of introduction and which thus forms an inner frame, is pivotally mounted in the outer frame and can be pivoted between a closed position and an open position. This construction is fairly complicated.

### SUMMARY OF THE INVENTION

The object of the present invention therefore is to provide a sliding window arrangement, which has a simpler construction, and more particularly has only one frame which is displaceable as well as pivotable.

According to the invention, this object is achieved by a sliding window arrangement, which is of the type defined by way of introduction and characterised in that

a holding means is arranged on the upper guide rail,

the lower guide rail has a stop means which is positioned so that the window, when on displacement in a direction towards said displacement end position it reaches this position, is stopped by the stop means and, owing to its kinetic energy, is tilted about an imaginary tilt axis extending perpendicular to the window to a tilted position, in which the lower guide means which is located at the lower, with regard to said direction rear, corner of the frame is disengaged from the lower guide rail and the upper guide means which is located at the upper, with regard to said direction front, corner of the frame engages the holding means on the upper guide rail in order to retain, in cooperation with the holding means, the window in the tilted position,

the two guide means located at the upper and lower, with regard to said direction front, corners of the frame being arranged to form in said tilted position said essentially vertical pivot shaft,

and the window has an operating means, by means of which the upper guide means which is located at the upper, with regard to said direction rear, corner of the frame is disengageable from the upper guide rail in order to allow the window in said tilted position to be pivoted from the closed position to the open position.

In a first preferred embodiment, the upper guide rail has a recess, the holding means comprises a receiving means which is arranged at one side of the upper guide rail and has a compartment which is located straight in front of the recess and adapted to receive the upper guide means which is located at the upper, with regard to said direction front, corner of the frame, and a spring means is arranged at the other side of the upper guide rail essentially straight in front of the recess and the compartment, the spring means being arranged, when the window reaches the tilted position, to insert through the recess essentially perpendicularly to the upper guide rail the upper guide means located at the upper, with regard to said direction front, corner of the frame into the compartment of the receiving means, which is arranged to hold said guide means in the compartment and thus keep the window in the tilted position.

In a second preferred embodiment, the upper guide means, which is located at the upper, with regard to said direction front, corner of the frame, has at its upper side a groove which is essentially V shaped in cross-section and which extends essentially perpendicular to the upper guide rail and whose groove wall, which with regard to said direction is the front wall, forms a stop lug, the holding means being a pawl which is mounted on the upper guide rail to be freely pivotable about a pivot shaft extending parallel to the groove and, when the window is in the tilted position, to engage in the groove while abutting against the bottom and stop lug thereof, and the pivot shaft of the pawl being positioned so that, when the window is in the tilted position, it is located above the groove.

Preferably the stop means is mounted on the lower guide rail to be pivotable about a pivot shaft extending perpendicular to the lower guide rail, the stop means being pivotable against spring action from an upper operative position, in which it is normally held, to a lower inoperative position, in which it allows displacement of the window from the displacement end position in said direction. The stop means is suitably arranged to cooperate with the lower guide means located at the lower, with regard to said displacement direction front, corner of the frame in order to stop the window.

The lower guide rail advantageously has a locking means, which is arranged to prevent unintentional displacement of the window from the displacement end position in the direction opposite to said direction. Advantageously the locking means is mounted on the lower guide rail to be pivotable about a pivot shaft extending perpendicular to the lower guide rail, the locking means being pivotable against spring action from an upper operative position, in which it is normally held, to a lower inoperative position, in which it allows displacement of the window from the displacement end position in the direction opposite to said direction. The locking means is suitably arranged to cooperate with the lower guide means located at the lower, with regard to said displacement direction front, corner of the frame in order to lock the window.

Each of the lower guide means preferably comprises a wheel which has a circumferential groove in its circumferential surface and is arranged to roll on the lower guide rail when this is placed in said groove. Each of the lower guide means preferably comprises also a fork-shaped part which from above straddles the upper portion of the lower guide rail and in which the wheel is mounted. The fork-shaped part of the lower guide means, which is located at the lower, with regard to said direction front, corner of the frame, advantageously has an upwardly extending pivot pin which is pivotally mounted in the frame.

Each of the upper guide means preferably comprises a fork-shaped part which from below straddles the lower portion of the upper guide rail.

In the first preferred embodiment, the fork-shaped part of the upper guide means, which is located at the upper, with regard to said direction front, corner of the frame, is suitably circular in cross-section and is located in axial alignment with said pivot pin in order to form, together with the pivot pin, said essentially vertical pivot shaft, when the fork-shaped part is inserted in the compartment of the receiving means.

In the second preferred embodiment, the fork-shaped part of the upper guide means, which is located at the upper, with regard to said direction front, corner of the frame, advantageously has a downwardly extending pivot pin which is pivotally mounted in the frame. The two pivot pins are suitably arranged together to form said essentially vertical pivot shaft.

### BRIEF DESCRIPTION OF THE DRAWINGS

The invention will now be described in more detail with reference to the accompanying drawings.

FIG. 1 is a front view and shows a first embodiment of a sliding window arrangement according to the present invention, a window included in the arrangement being shown in an arbitrary displacement position.

FIG. 2 is a front view and shows the arrangement in FIG. 1 with the window in a displacement end position and in a tilted state.

FIG. 3 shows the arrangement in the direction of the arrow III in FIG. 1.

FIG. 4 shows the arrangement in the direction of the arrow IV in FIG. 2.

FIG. 5 shows the arrangement in the direction of the arrow V in FIG. 1 and with a lower portion of the window broken away.

FIG. 6 is a top plan view of a portion of the window when this is located close to the displacement end position.

FIG. 7 corresponds to FIG. 6 but shows the same portion when the window is in the displacement end position.

FIG. 8 corresponds to FIGS. 6 and 7 but shows the same portion when the window is in the displacement end position and in a tilted state.

FIG. 9 is a front view and shows a second embodiment of a sliding window arrangement according to the invention, a window included in the arrangement being shown in a displacement position close to a displacement end position.

FIG. 10 is a front view and shows the arrangement in FIG. 9 with the window in the displacement end position.

FIG. 11 is a front view and shows the arrangement in FIGS. 9 and 10 with the window in the displacement end position and in a tilted state.

FIG. 12 is a front view and shows the arrangement in FIGS. 9-11 with a stop means included in the arrangement in a moved-away position and with the window in a position slightly beyond the displacement end position.

FIG. 13 shows the portion of the arrangement encircled in FIG. 9 on a larger scale.

FIG. 14 shows the portion of the arrangement encircled in FIG. 10 on a larger scale.

FIG. 15 shows the same encircled portion of the arrangement with the window in the displacement end position and in an overtilted state.

FIG. 16 shows the portion of the arrangement encircled in FIG. 11 on a larger scale.

FIG. 17 shows the portion of the arrangement encircled in FIG. 12 on a larger scale.

FIG. 18 shows the same encircled portion of the arrangement with the window in a position slightly further beyond the displacement end position in relation to FIGS. 12 and 17.

FIG. 19 shows the same encircled portion of the arrangement with the window in a position slightly further beyond the displacement end position in relation to FIG. 18.

FIG. 20 shows the arrangement in the direction of the arrow XX in FIG. 9 with a lower and an upper portion of the window broken away.

### DESCRIPTION OF PREFERRED EMBODIMENTS

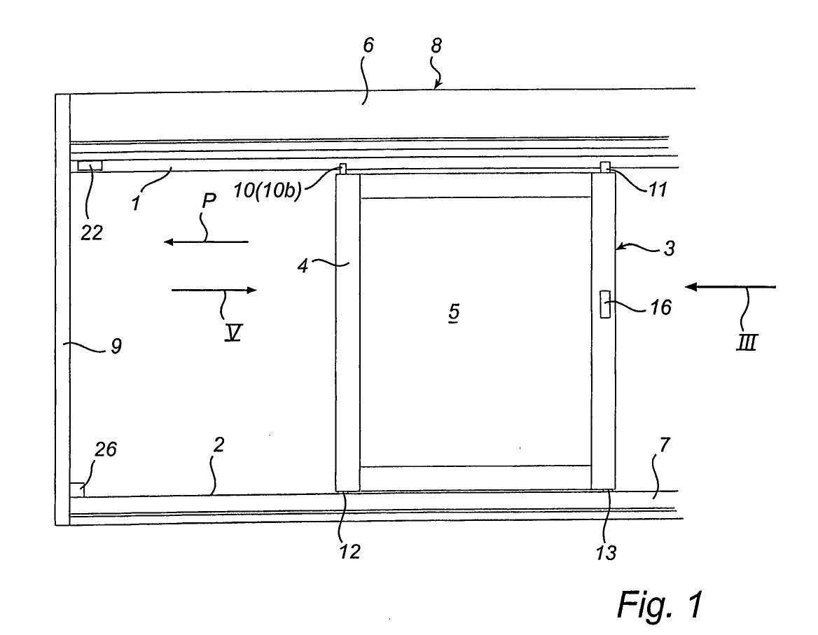

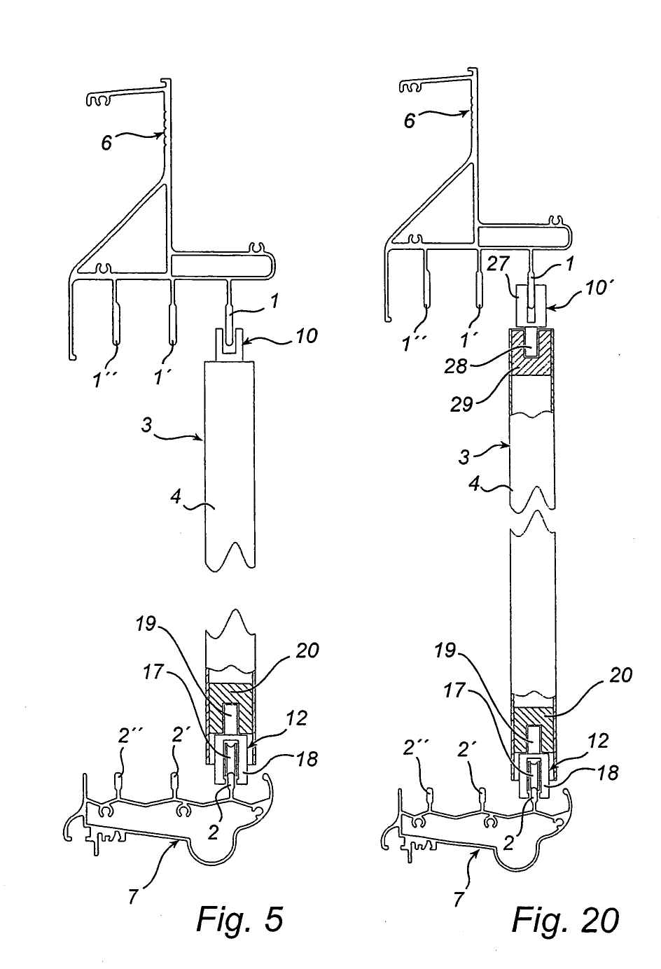

The sliding window arrangement according to the first embodiment as shown in FIGS. 1-8 has an upper horizontal guide rail 1 and a lower horizontal guide rail 2 arranged straight below and parallel to the upper guide rail. The arrangement further has a vertically arranged window 3 which has a rectangular frame 4 and a glass pane 5 mounted therein. The window 3 is mounted between the guide rails 1 and 2 and is displaceable along the same.

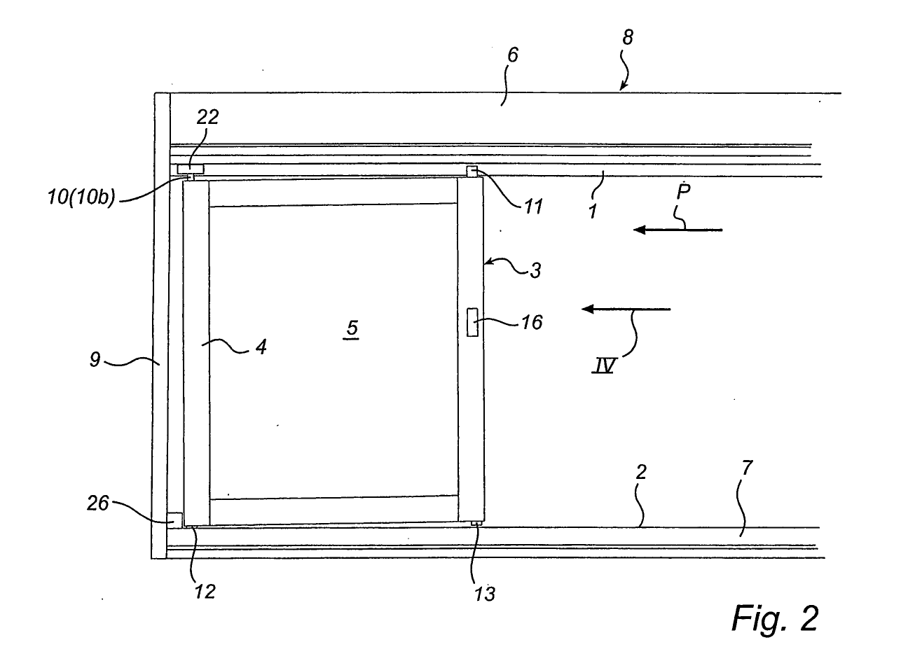

In the shown embodiment, the upper and the lower guide rail 1 and 2 constitute one of three guide rails 1, 1′, 1″ and 2, 2′, 2″ respectively which are formed on an upper aluminium sectional element 6 and a lower aluminium sectional element 7 respectively. The two sectional elements 6 and 7 constitute horizontal frame parts in a mounting frame 8, which also has two vertical frame parts, of which one 9 is shown in FIGS. 1 and 2. The mounting frame 8 is included in an arrangement for glazing in a balcony and covers a balcony side. A window (not shown) which is identical to the window 3, is mounted between each pair of upper and lower guide rails 1′, 2′ and 1″, 2″ and is, like the window 3, displaceable along its guide rails.

The frame 4 has in the vicinity of each of its two upper corners an upper guide means 10, 11 which engages the upper guide rail 1, and in the vicinity of each of its two lower corners a lower guide means 12, 13 which engages the lower guide rail 2. These guide means 10-13 hold the window 3 in place on the guide rails 1 and 2.

The lower guide means 13, which is located at the lower, with regard to one displacement direction P of the window 3 (to the left in FIGS. 1 and 2) rear, corner of the frame 4 comprises a wheel 14 which has a circumferential groove in its circumferential surface and is arranged to roll on the lower guide rail 2 when this is placed in the groove. This guide means 13 also comprises a fork-shaped part 15, which is attached to the frame 4 and which with its two legs from above straddles the upper portion of the lower guide rail 2. The wheel 14 is supported by and rotatably mounted between the legs of the fork-shaped part 15.

The upper guide means 11, which is located at the upper, with regard to the displacement direction P rear, corner of the frame 4, is a fork-shaped part, which with its two legs from below straddles the lower portion of the upper guide rail 1. This fork-shaped part is connected to an operating handle 16 by means of a vertical operating bar (not shown), which is arranged in the vertical, with regard to the displacement direction P rear, frame part of the frame 4. The operating rod, and thus the guide means 11, is biased upwardly by a spring. The guide means 11 can be disengaged from the upper guide rail 1 by the operating handle 16 being depressed.

The lower guide means 12, which is located at the lower, with regard to the displacement direction P front, corner of the frame 4, comprises a wheel 17, which has a circumferential groove in its circumferential surface and is arranged to roll on the lower guide rail 2 when this is placed in the groove. This guide means 12 also comprises a fork-shaped part 18, which with its two legs from above straddles the upper portion of the lower guide rail 2. The wheel 17 is supported by and rotatably mounted between the legs of the fork-shaped part 18. The fork-shaped part 18 has an upwardly extending vertical pivot pin 19, which is pivotally mounted in a block 20 which is fixed inside the vertical, with regard to the displacement direction P front, frame part of the frame 4.

As will be seen, the window is supported on the lower guide rail 2 by the two wheels 14 and 17.

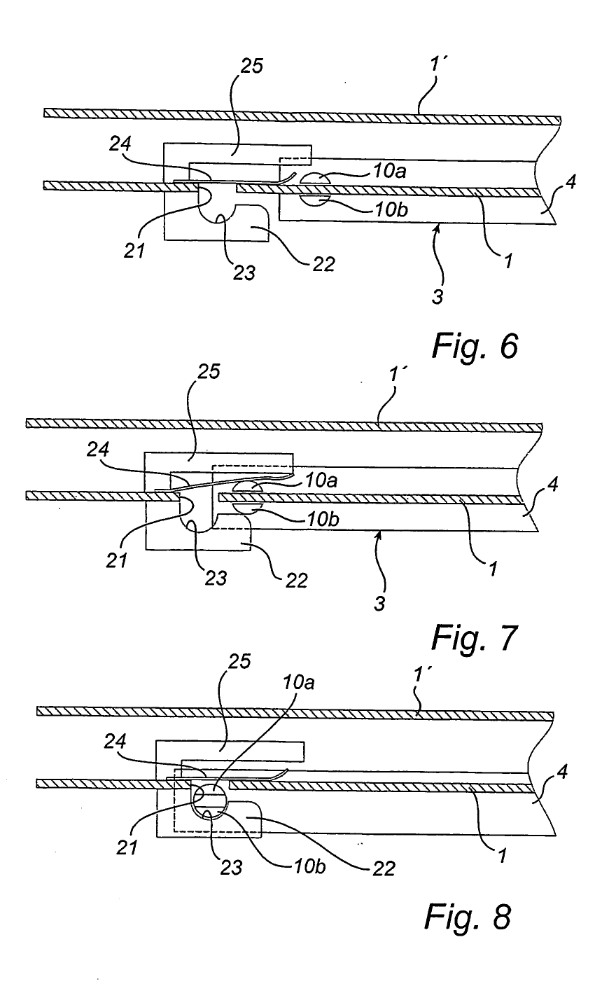

The upper guide means 10, which is located at the upper, with regard to the displacement direction P front, corner of the frame 4, is a fork-shaped part, which with its two legs 10a and 10b (see FIGS. 6 and 7) from below straddles the lower portion of the upper guide rail 1. This fork-shaped part is circular in cross-section and arranged in axial alignment with the pivot pin 19 in order to form together with the same a pivot shaft in a manner that will be described in more detail below, about which the window 3 is pivotable when it is in a displacement end position and takes a tilted state.

The upper guide rail 1 has in the vicinity of the vertical frame part 9 of the mounting frame 8 a recess 21, which extends from the underside of the upper guide rail 1 up to a level slightly above the upper end of the guide means 10 and whose extent in the longitudinal direction of the upper guide rail 1 is slightly greater than the diameter of the guide means 10 (10a, 10b) (see FIGS. 6-8). A receiving means 22, which has the shape of a block, is attached to one side of the upper guide rail 1 and has a compartment 23 which is positioned straight in front of the recess 21 and adapted to receive the guide means 10 (see FIG. 8). The compartment 23 has a part-circular shape in horizontal cross-section with a diameter which is slightly greater than the diameter of the guide means 10. A leaf spring 24 is attached to the other side of the upper guide rail 1 and with regard to the displacement direction P in front of the recess 21 and extends over the recess 21 rearwards with regard to the displacement direction P. The leaf spring 24 is at its free rear end slightly curved outwards from the upper guide rail 1. A spring abutment 25, which is L shaped in horizontal cross-section, is attached to said other side of the upper guide rail 1 and has essentially the same extent along the upper guide rail 1 as the leaf spring 24.

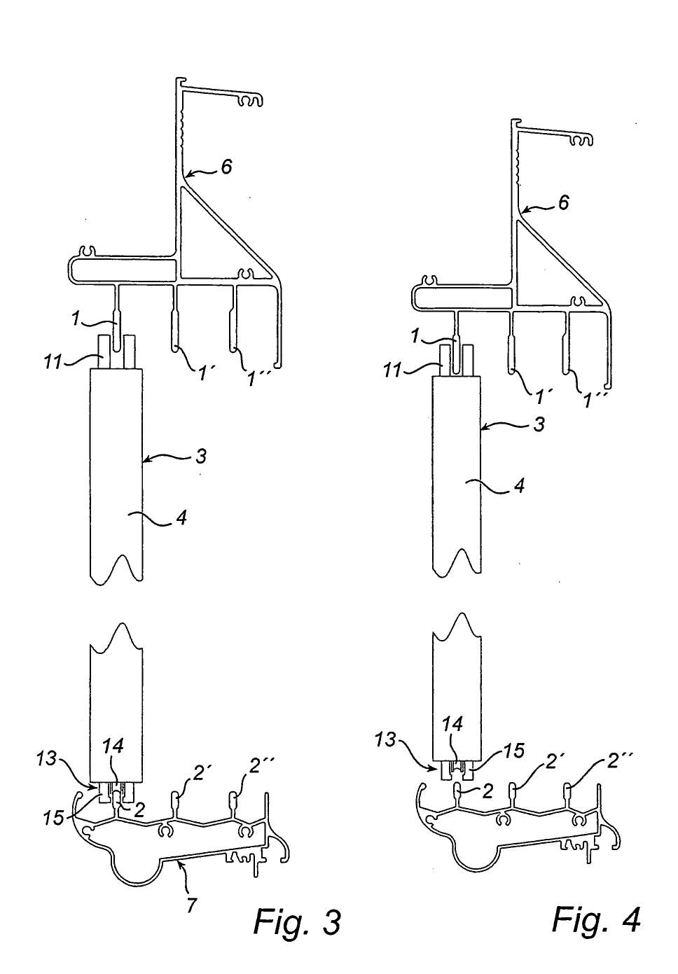

A stop lug 26 (see FIGS. 1 and 2) is attached to the lower guide rail 2 in the vicinity of the vertical frame part 9 of the mounting frame 8. It should be noted that for the sake of clarity the stop lug 26, as well as the components 22, 24 and 25, has been omitted in FIGS. 3 and 4. The stop lug 26 is positioned so that the window 3, when on displacement in the direction P it reaches the above-mentioned displacement end position, abuts against the stop lug 26 in its lower, with regard to the displacement direction P front, frame corner and, owing to its kinetic energy, is tilted about an imaginary tilt axis extending perpendicular to the window to a tilted position (FIG. 2). When the window 3 is tilted to this tilted position, one fork leg 10a of the guide means 10 presses the leaf spring 24 into engagement with the L leg, parallel with the upper guide rail 1, of the spring abutment 25 (see FIG. 7). When the window 3 has reached the tilted position, the guide means 10 (10a, 10b) is located straight in front of the recess 21 in the upper guide rail 1 and is moved by the tightened leaf spring 24 into the compartment 23 of the receiving means 22 (see FIG. 8). The receiving means 22 forms a holding means which holds the guide means 10 in the compartment 23 and thus keeps the window 3 in the tilted position. When the window 3 is in the tilted position, the guide means 13 is, as shown in FIGS. 2 and 4, raised and disengaged from the lower guide rail 2.

When the window 3 is in the above-described tilted position and its upper, with regard to the displacement direction P front, frame corner is slightly projected from the upper guide rail 1 perpendicular to the same, the upper guide means 10, (10a, 10b) forms, together with the pivot pin 19 of the lower guide means 12, an essentially vertical pivot shaft, about which the window 3 is pivotable.

When the window 3 is to be opened, it is thus displaced to the displacement end position so that it will there be tilted to the tilted position, whereby the upper guide means 10 is inserted into the compartment 23 of the receiving means 22. Subsequently, the operating handle 16 is pressed down a short distance to disengage the upper guide means 11 from the upper guide rail 1 and then the window 3 is pivoted about the pivot shaft formed by the upper guide means 10 and the pivot pin 19 to the desired opening position.

As the window 3 is then pivoted back to be closed, the operating handle 16 is to be pressed down a distance in the same way so as to release, when the window 3 is closed again but still is in the tilted position with the upper front frame corner projected from the upper guide rail 1, the upper guide means 11 into engagement with the upper guide rail 1. The upper guide means 11 may have such a bevel (not shown) in its upper portion that, when on closing the window 3 the upper guide means abuts against the upper guide rail 1, the upper guide means is moved downwards a distance by the upper guide rail so as then to be moved upwards again by the spring-biased operating rod into engagement with the upper guide rail 1.

Once the window 3 has been closed in this manner, its upper, with regard to the displacement direction P front, frame corner is pressed in towards the upper guide rail 1 so that the upper guide means 10 is, against the action of the leaf spring 24, pressed out of the compartment 23 of the receiving means 22. When the guide means 10 reaches the position in which the space between its two fork legs 10a and 10b is located straight in front of the upper guide rail 1, the window 3 tilts about the tilt axis by its own weight back to its non-tilted position, whereby the guide means 13 is again brought into engagement with the lower guide rail 2. The window 3 can now be displaced to an arbitrary position in the direction opposite to the displacement direction P.

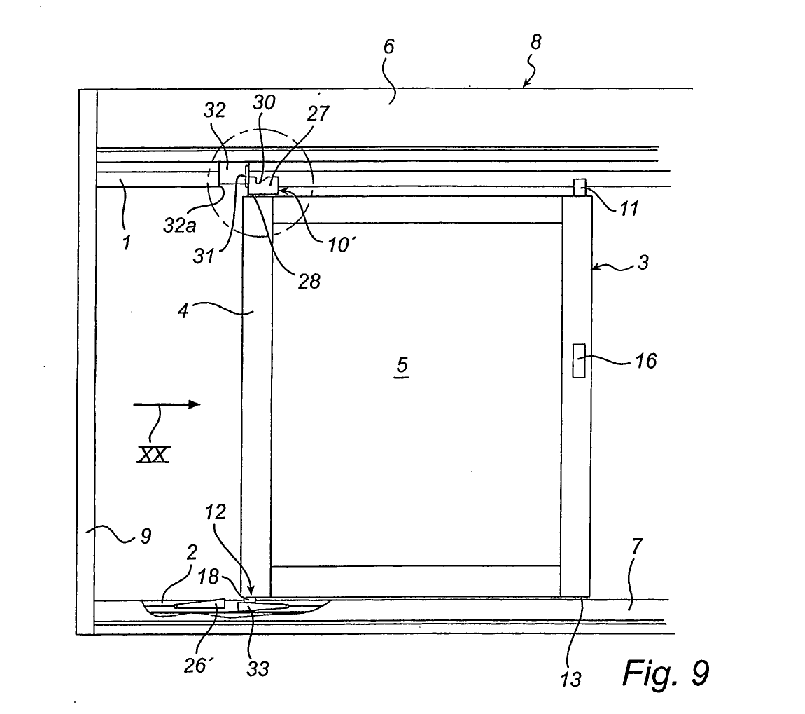

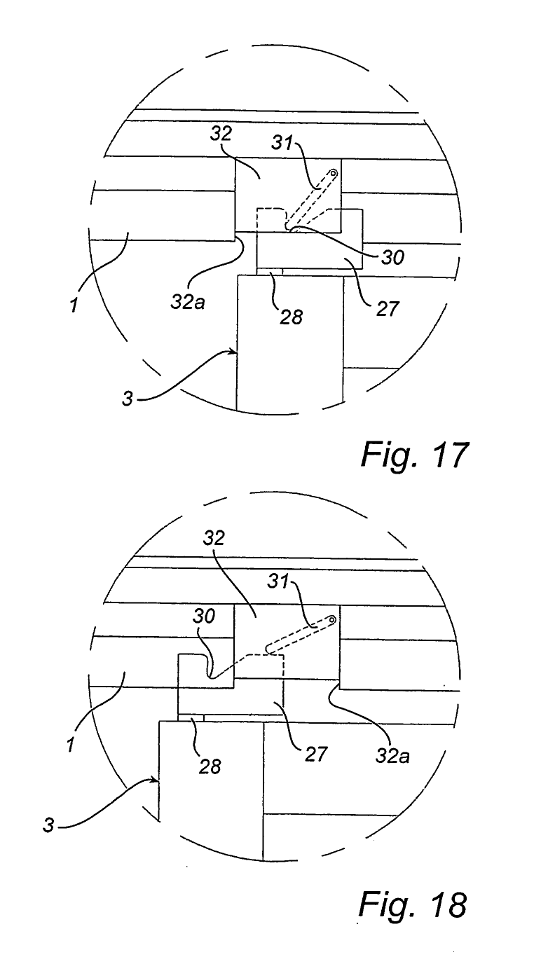

The sliding window arrangement according to the second embodiment as shown in FIGS. 9-20 differs from the first embodiment shown in FIGS. 1-8 essentially only by the fact that its stop means, its holding means and its upper guide means, which is located at the upper, with regard to the displacement direction P front, corner of the frame, have a different construction, and that its stop means is combined with a locking means. Equivalent components in the two embodiments have been given the same reference numerals, which, when there is a difference between the components, have been given prime marks in FIGS. 9-20. The components in the second embodiment which are the same as corresponding components in the first embodiment will here not be described once more, but reference is made to the above description.

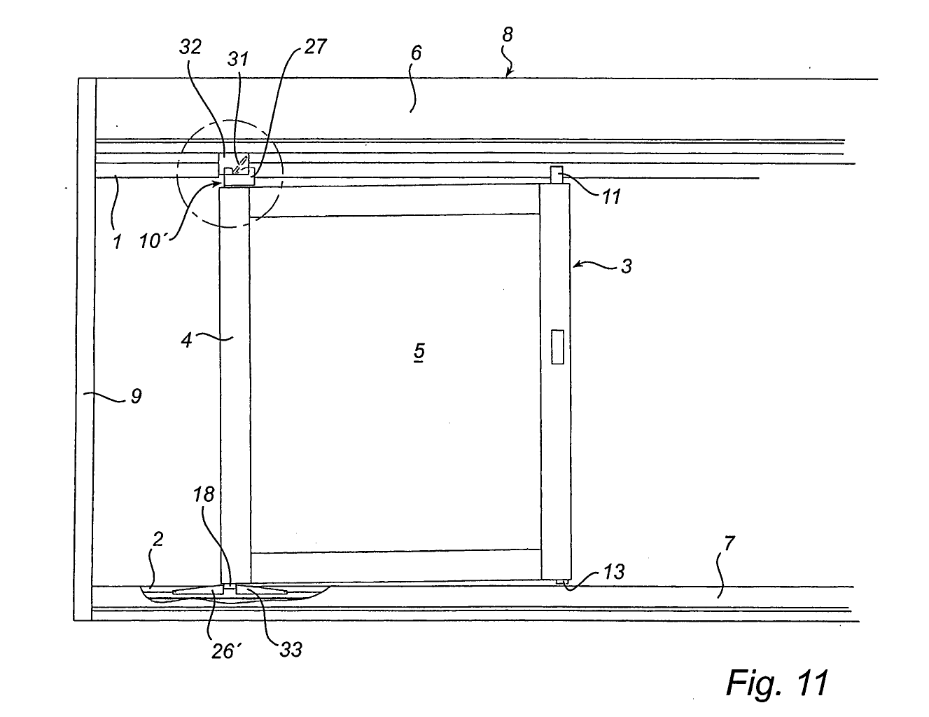

The upper guide means 10′, which is located at the upper, with regard to the displacement direction P front, corner of the frame 4, comprises a fork-shaped part 27, which with its two legs from below straddles the lower portion of the upper guide rail (see FIG. 20). This fork-shaped part 27 has a downwardly extending vertical pivot pin 28 which is pivotally mounted in a block 29, which is attached inside the vertical frame part of the frame 4, which is the front frame part with regard to the displacement direction P. The pivot pin 28 is positioned in axial alignment with the pivot pin 19 so as to form, together with the latter, the pivot shaft about which the window 3 is pivotable when it is in the displacement end position and takes a tilted state (FIGS. 11 and 16).

The fork-shaped part 27 has at its upper side a horizontal groove 30 which is essentially V shaped in cross-section and extends perpendicular to the upper guide rail 1 and whose groove wall, which is the front wall with regard to the displacement direction P, forms a stop lug and whose groove wall, which is the rear wall with regard to the displacement direction P, is inclined downwards/forwards.

The holding means is a pawl 31, which is mounted in a mounting part 32 and is freely pivotable about a pivot shaft extending parallel to the groove 30, the mounting part in turn being attached to the upper sectional element 6 straight in front of a recess 32a formed therein, which extends a distance upwards from the underside of the upper guide rail 1. The mounting part 32 has, in cross-section perpendicular to the upper guide rail 1, the shape of an inverted U, between the legs of which the pawl 31 is arranged. The distance between these legs equals the width of the fork-shaped part 27 which is guided by these legs in the portion of the upper guide rail 1 where the recess 32a is located, i.e. where it cannot be guided by the upper guide rail 1.

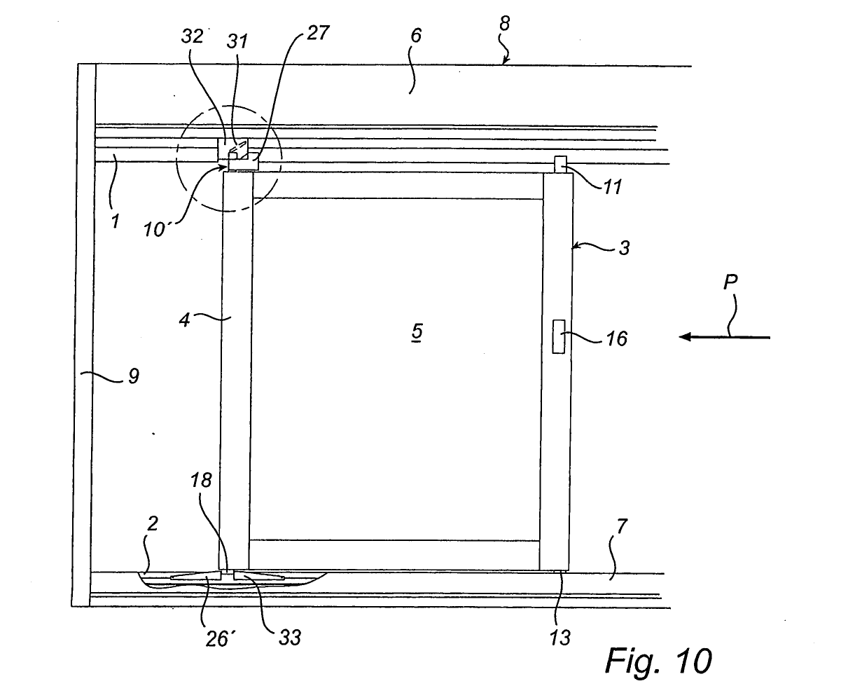

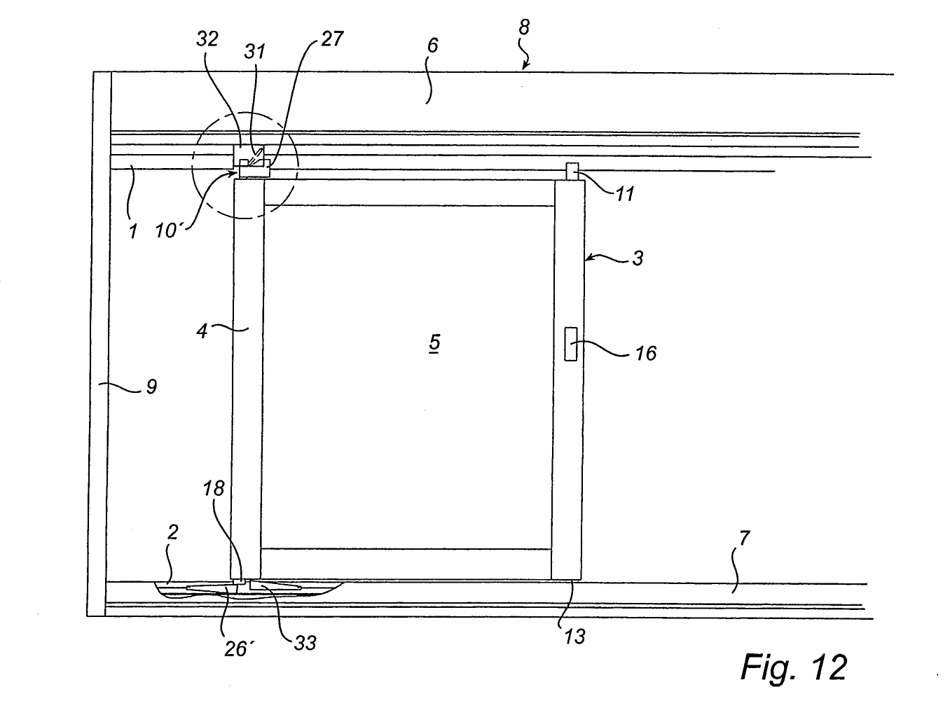

The stop means 26′ has a height which decreases in a wedge-shaped manner in the displacement direction P and is at its narrow end, which with regard to the displacement direction P is the front end, mounted on the lower guide rail 2 to be pivotable about a pivot shaft extending perpendicular to the lower guide rail 2. The stop means 26′ is pivotable against the action of a spring (not shown), from an upper operative position (FIGS. 9, 10 and 11), in which it is normally held to function as a stop means, and a lower inoperative position (FIG. 12), in which it allows displacement of the window 3 from the displacement end position (FIGS. 10 and 11) in the displacement direction P. When the stop means 26′ is in its upper position, its upper side forms a ramp surface sloping downwards in the displacement direction P.

A locking means 33 has a height decreasing in a wedge-shaped manner in the direction opposite to the displacement direction P and is at its narrow end, which with regard to the displacement direction P is the rear end, mounted on the lower guide rail 2 to be pivotable about a pivot shaft extending perpendicular to the lower guide rail 2. The locking means 33 is against the action of a spring (not shown) pivotable from an upper operative position (FIGS. 10, 11 and 12), in which it is normally held to function as a locking means, and a lower inoperative position (FIG. 9), in which it allows displacement of the window 3 from the displacement end position (FIGS. 10 and 11) in the direction opposite to the displacement direction P. When the locking means 33 is in its upper position, its upper side forms a ramp surface sloping upwards in the displacement direction P.

The stop means 26′ and the locking means 33 are spaced from each other so as to form a gap which has the same extent in the longitudinal direction of the lower guide rail 2 as the fork-shaped part 18 of the lower, with regard to the displacement direction P front, guide means 12.

When the window 3 is displaced from a position to the right of the position shown in FIG. 9 in the displacement direction P, the fork-shaped part 18 of the guide means 12 abuts, in its lower portion, against the ramp surface formed by the locking means 33 (FIG. 9) and, in the continued displacement of the window 3, presses down the locking means to its lower position. When the window 3 reaches the displacement end position (FIG. 10), the fork-shaped part 18 abuts against the stop means 26′ and the locking means 33 is returned by spring action to its upper position, so that the fork-shaped part 18 is locked between the stop means 26′ and the locking means 33.

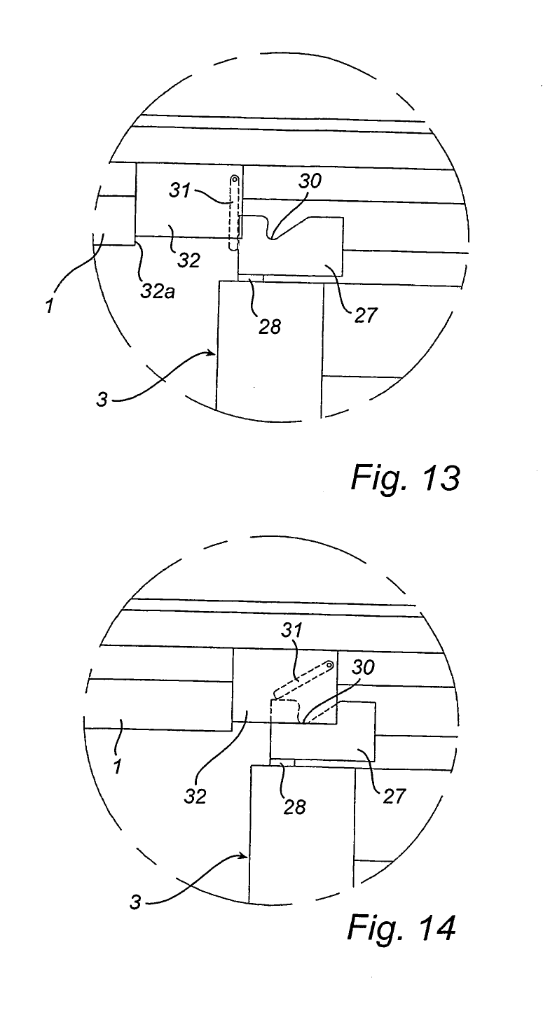

During the described displacement, also the fork-shaped part 27 of the upper guide means 10′ comes into abutment against the vertically hanging pawl 31 (FIGS. 9 and 13) and pivots this a distance clockwise (FIGS. 10 and 14).

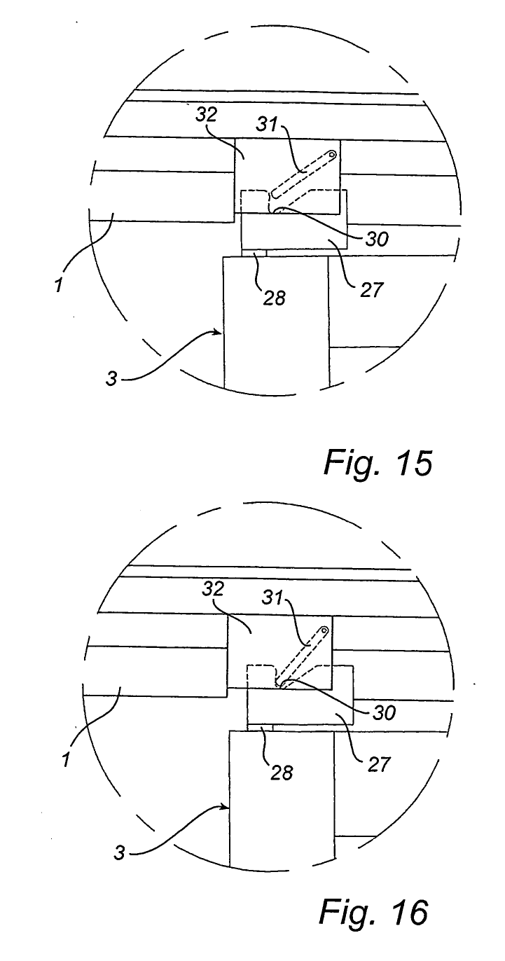

When the fork-shaped part 18 abuts against the stop means 26′, the window 3 is owing to its kinetic energy tilted about an imaginary tilt axis extending perpendicular to the window past a tilted position (FIGS. 11 and 16) to an overtilted position (FIG. 15), in which the free end of the pawl 31, which is pivoted clockwise by the fork-shaped part 27, passes the upper edge of the wall of the groove 30, which is the front wall with regard to the displacement direction P, whereby the pawl 31 falls down by its own weight into the groove 30 while pivoting in the counter-clockwise direction. Now the window 3 falls by its own weight back to the tilted position (FIGS. 11 and 16). When the window 3 is in the tilted position, the pawl 31 engages in the groove 30 while abutting against the bottom of the groove and the stop lug formed by the front groove wall. The pawl 31 thus keeps the window 3 in the tilted position, in which besides, in the same way as in the first embodiment, the guide means 13 is raised and disengaged from the lower guide rail 2 (FIG. 11). If, when the window 3 is in the tilted position, the operating handle 16 is pressed down a short distance to disengage the upper guide means 11 from the upper guide rail 1, the window 3 can be pivoted about the pivot shaft formed by the two pivot pins 19 and 28 to the desired opening position.

When the window 3 is then pivoted back to be closed, the operating handle 16 is in the same way pressed down a distance in order to release, when the window 3 is again closed, but still is in the tilted position, the upper guide means 11 into engagement with the upper guide rail 1. Also in this embodiment, the upper guide means 11 may have a bevel of the kind as described for the guide means 11 in the first embodiment.

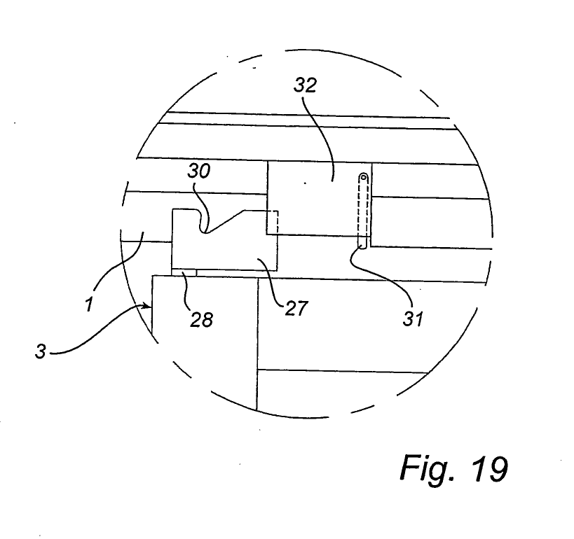

Once the window 3 has been closed in this way, the stop means 26′ is to be pressed down to its lower position, so that the fork-shaped part 18 is released. After that, the window 3 tilts by its own weight back to a non-tilted position, whereby the guide means 13 is again brought into engagement with the lower guide rail 2. In this tilting back, the fork-shaped part 18 will be positioned above the stop means 26′ and thus keeps this in the lower position (FIG. 12). The window 3 can now be displaced further in the displacement direction P in order to release the pawl 31. In this further displacement, the pawl 31 is pivoted clockwise (FIG. 18) and finally reaches such a position relative to the fork-shaped part 27 that it falls down by its own weight to the vertical position by pivoting in the counter-clockwise direction (FIG. 19). Without being locked by the pawl 31 and the locking means 33, if this has been pressed down to its lower position, the window 3 can now be displaced to an arbitrary position in the direction opposite to the displacement direction P.

1. A sliding window arrangement, which has an upper and a lower horizontal guide rail (1, 2) and a vertical window (3) which is mounted between the guide rails and displaceable laterally along the same, said window having a rectangular frame (4) with a pane (5) mounted therein, and in the vicinity of each of its two upper frame corners having an upper guide means (10, 10′, 11), which engages the upper guide rail (1), and in the vicinity of each of its two lower frame corners having a lower guide means (12, 13), which engages the lower guide rail (2), the window (3) in a displacement end position being pivotable about an essentially vertical pivot shaft positioned at one lateral edge of the window between a closed position, in which it extends along the guide rails (1, 2), and an open position, wherein:
a holding means (22, 23) is arranged on the upper guide rail (1),
the lower guide rail (2) has a stop means (26, 26′) which is positioned so that the window (3), when on displacement in a direction (P) towards said displacement end position it reaches this position, is stopped by the stop means (26, 26′) and, owing to its kinetic energy, is tilted about an imaginary tilt axis extending perpendicular to the window (3) to a tilted position, in which the lower guide means (13) which is located at the lower, with regard to said direction (P) rear, corner of the frame (4) is disengaged from the lower guide rail (2) and the upper guide means (10, 10′) which is located at the upper, with regard to said direction (P) front, corner of the frame (4) engages the holding means (22, 31) on the upper guide rail (1) in order to retain, in cooperation with the holding means, the window (3) in the tilted position,
the two guide means (10, 10′ and 12) located at the upper and lower, with regard to said direction (P) front, corners of the frame (4) being arranged to form in said tilted position said essentially vertical pivot shaft,
and the window (3) has an operating means (16), by means of which the upper guide means (11) which is located at the upper, with regard to said direction (P) rear, corner of the frame (4) is disengageable from the upper guide rail (1) in order to allow the window (3) in said tilted position to be pivoted from the closed position to the open position.

2. A sliding window arrangement as claimed in claim 1, in which
the upper guide rail (1) has a recess (21),
the holding means comprises a receiving means (22) which is arranged at one side of the upper guide rail (1) and has a compartment (23) which is located straight in front of the recess and adapted to receive the upper guide means (10) which is located at the upper, with regard to said direction (P) front, corner of the frame (4), and
a spring means (24) is arranged at the other side of the upper guide rail (1) essentially straight in front of the recess (21) and the compartment (23),
the spring means (24) being arranged, when the window (3) reaches the tilted position, to insert through the recess (21) essentially perpendicularly to the upper guide rail (1) the upper guide means (10) located at the upper, with regard to said direction (P) front, corner of the frame (4) into the compartment (23) of the receiving means (22), which is arranged to hold said guide means (10) in the compartment and thus keep the window (3) in the tilted position.

3. A sliding window arrangement as claimed in claim 1, in which the upper guide means (10′), which is located at the upper, with regard to said direction (P) front, corner of the frame (4), has at its upper side a groove (30) which is essentially V shaped in cross-section and which extends essentially perpendicular to the upper guide rail (1) and whose groove wall, which with regard to said direction (P) is the front wall, forms a stop lug,
the holding means being a pawl (31) which is mounted on the upper guide rail (1) to be freely pivotable about a pivot shaft extending parallel to the groove and, when the window (3) is in the tilted position, to engage in the groove (30) while abutting against the bottom and stop lug thereof, and
the pivot shaft of the pawl (31) being positioned so that, when the window (3) is in the tilted position, it is located above the groove.

4. A sliding window arrangement as claimed in claim 1, in which the stop means (26′) is mounted on the lower guide rail (2) to be pivotable about a pivot shaft extending perpendicular to the lower guide rail (2), the stop means (26′) being pivotable against spring action from an upper operative position, in which it is normally held, to a lower inoperative position, in which it allows displacement of the window (3) from the displacement end position in said direction (P).

5. A sliding window arrangement as claimed in claim 4, in which the stop means (26′) is arranged to cooperate with the lower guide means (12) located at the lower, with regard to said displacement direction (P) front, corner of the frame (4) in order to stop the window (3).

6. A sliding window arrangement as claimed in claim 1, in which the lower guide rail (2) has a locking means (33), which is arranged to prevent unintentional displacement of the window (3) from the displacement end position in the direction opposite to said direction (P).

7. A sliding window arrangement as claimed in claim 6, in which the locking means (33) is mounted on the lower guide rail to be pivotable about a pivot shaft extending perpendicular to the lower guide rail (2), the locking means (33) being pivotable against spring action from an upper operative position, in which it is normally held, to a lower inoperative position, in which it allows displacement of the window (3) from the displacement end position in the direction opposite to said direction (P).

8. A sliding window arrangement as claimed in claim 6, in which the locking means (33) is arranged to cooperate with the lower guide means (12) located at the lower, with regard to said displacement direction (P) front, corner of the frame (4) in order to lock the window (3).

9. A sliding window arrangement as claimed in claim 1, in which each of the lower guide means (12, 13) comprises a wheel (14, 17) which has a circumferential groove in its circumferential surface and is arranged to roll on the lower guide rail (2) when this is placed in said groove.

10. A sliding window arrangement as claimed in claim 9, in which each of the lower guide means (12, 13) also comprises a fork-shaped part (15, 18) which from above straddles the upper portion of the lower guide rail (2) and in which the wheel (14, 17) is mounted.

11. A sliding window arrangement as claimed in claim 10, in which the fork-shaped part (18) of the lower guide means (12), which is located at the lower, with regard to said direction (P) front, corner of the frame (4), has an upwardly extending pivot pin (19) which is pivotally mounted in the frame (4).

12. A sliding window arrangement as claimed in claim 1, in which each of the upper guide means (10, 10′, 11) comprises a fork-shaped part (27) which from below straddles the lower portion of the upper guide rail (1).

13. A sliding window arrangement as claimed in claim 2, in which each of the lower guide means (12, 13) comprises a wheel (14, 17) which has a circumferential groove in its circumferential surface and is arranged to roll on the lower guide rail (2) when this is placed in said groove, in which each of the lower guide means (12, 13) also comprises a fork-shaped part (15, 18) which from above straddles the upper portion of the lower guide rail (2) and in which the wheel (14, 17) is mounted, in which the fork-shaped part (18) of the lower guide means (12), which is located at the lower, with regard to said direction (P) front, corner of the frame (4), has an upwardly extending pivot pin (19) which is pivotally mounted in the frame (4), in which each of the upper guide means (10, 10′, 11) comprises a fork-shaped part (27) which from below straddles the lower portion of the upper guide rail (1), and in which the fork-shaped part of the upper guide means (10), which is located at the upper, with regard to said direction (P) front, corner of the frame (4), is circular in cross-section and is located in axial alignment with said pivot pin (19) in order to form, together with the pivot pin (19), said essentially vertical pivot shaft, when the fork-shaped part is inserted in the compartment (23) of the receiving means (22).

14. A sliding window arrangement as claimed in claim 3, in which each of the upper guide means (10, 10′, 11) comprises a fork-shaped part (27) which from below straddles the lower portion of the upper guide rail (1), and in which the fork-shaped part (27) of the upper guide means (10′), which is located at the upper, with regard to said direction (P) front, corner of the frame (4), has a downwardly extending pivot pin (28) which is pivotally mounted in the frame (4).

15. A sliding window arrangement as claimed in claim 14, in which each of the lower guide means (12, 13) comprises a wheel (14, 17) which has a circumferential groove in its circumferential surface and is arranged to roll on the lower guide rail (2) when this is placed in said groove, in which each of the lower guide means (12, 13) also comprises a fork-shaped part (15, 18) which from above straddles the upper portion of the lower guide rail (2) and in which the wheel (14, 17) is mounted, in which the fork-shaped part (18) of the lower guide means (12), which is located at the lower, with regard to said direction (P) front, corner of the frame (4), has an upwardly extending pivot pin (19) which is pivotally mounted in the frame (4), and in which the two pivot pins (19 and 28) are arranged together to form said essentially vertical pivot shaft.

16. A sliding window arrangement as claimed in claim 2, in which the stop means (26′) is mounted on the lower guide rail (2) to be pivotable about a pivot shaft extending perpendicular to the lower guide rail (2), the stop means (26′) being pivotable against spring action from an upper operative position, in which it is normally held, to a lower inoperative position, in which it allows displacement of the window (3) from the displacement end position in said direction (P).

17. A sliding window arrangement as claimed in claim 2, in which the lower guide rail (2) has a locking means (33), which is arranged to prevent unintentional displacement of the window (3) from the displacement end position in the direction opposite to said direction (P).

18. A sliding window arrangement as claimed in claim 7, in which the locking means (33) is arranged to cooperate with the lower guide means (12) located at the lower, with regard to said displacement direction (P) front, corner of the frame (4) in order to lock the window (3).

19. A sliding window arrangement as claimed in claim 2, in which each of the lower guide means (12, 13) comprises a wheel (14, 17) which has a circumferential groove in its circumferential surface and is arranged to roll on the lower guide rail (2) when this is placed in said groove.

20. A sliding window arrangement as claimed in claim 2, in which each of the upper guide means (10, 10′, 11) comprises a fork-shaped part (27) which from below straddles the lower portion of the upper guide rail (1).
